(19) United States
(12) Patent Application Publication
(10) Pub. No.: US 2012/0086663 A1
(43) Pub. Date: Apr. 12, 2012

(54) MOBILE TERMINAL, LANGUAGE SETTING PROGRAM AND LANGUAGE SETTING METHOD

(75) Inventor: Naoki Matsuo, Osaka (JP)

(73) Assignee: KYOCERA CORPORATION, Kyoto (JP)

(21) Appl. No.: 13/378,519

(22) PCT Filed: Jun. 22, 2010
(86) PCT No.: PCT/JP2010/060510

§ 371 Date: Dec. 15, 2011

(30) Foreign Application Priority Data
Jun. 24, 2009 (JP) 2009-150202

(51) Int. Cl. G06F 3/041

(52) U.S. Cl. 345/173

(57) ABSTRACT

A mobile terminal 10 has a display 26 and a touch panel 36 provided on the display 26. A standby screen displayed on the display 26 includes a plurality of icons for executing functions. In addition, on the display 26, a specific region (60) independent of selection of an icon is set. When a handwriting character is input within the specific region (60) by a touch operation, character recognition is performed on the handwriting character. For example, if the characters of the recognition result are hiragana characters, the processor 20 specifies them as Japanese and a change of the in-use language is requested by a GUI described in Japanese. Then, the processor 20 sets the language to be used in the mobile terminal 10 to Japanese in response to a touch operation of accepting the change.

### TECHNICAL FIELD

The present invention relates to mobile terminals. More specifically, the present invention relates to a mobile terminal capable of changing setting of an in-use language.

### BACKGROUND ART

Conventionally, apparatuses capable of changing the setting of an in-use language have been known, and one example of such a kind of apparatuses is disclosed in a patent document 1. A printer of the background art has an operation panel on which optional items, up and down keys, right and left keys, a menu key, etc. are displayed, and on the operation panel, two or more languages, such as Japanese, English and the like are settable. In the printer of an embodiment 1, when the menu key displayed on the operation panel is operated, optional items selectable by the up and the down keys and the right and the left keys are displayed. Then, the user switches to a language change screen by repetitively operating the up and the down keys and the right and the left keys with reference to the optional items. In addition, the user can change the setting of the language to be displayed on the operation panel by performing a language change operation.

Also, in the printer of an embodiment 2, the optional item for switching to the language changing screen is constantly displayed on the touch panel, and therefore, the user can more easily perform the language change operation.
[Patent Document 1] Japanese Patent Application Laying-Open No. 2000-305690[G06F 3/00, B41J 29/42, H04N 1/00]

### SUMMARY OF THE INVENTION

### Problems to be Solved by the Invention

However, in the embodiment 1 of the background art, in a case that the language of the optional items is described in Japanese, a user who cannot understand Japanese cannot accurately operate the up and the down keys, and the right and the left keys, so that the user cannot easily perform a setting change to a language that the user can understand. Also in the embodiment 2 of the background art, the optional item for switching to the language changing screen is constantly displayed on the touch panel, and whereby, convenience of the user is improved, but if it applied to the mobile terminal, the following problem occurs.

Mobile terminals are often used individually, and once the setting of the in-use language is performed, the problem that the user cannot understand the displayed language is solved. Thus, in the mobile terminals having a display not so large, the optional item (icon) for language setting is constantly displayed, resulting in useless constant display of the optional item. That is, the embodiment 2 of the background art is not an effective means for solving the problem in the mobile terminals having a limited display range.

Therefore, it is a primary object of the present invention to provide a novel mobile terminal, a language setting program and a language setting method.

Another object of the present invention is to provide a mobile terminal, a language setting program and a language setting method capable of preventing useless utilization of a display area and easily setting a language.

### Means for Solving the Problems

The present invention employs following features in order to solve the above-described problems. It should be noted that reference numerals and the supplements inside the parentheses show one example of a corresponding relationship with the embodiments described later for easy understanding of the present invention, and do not limit the present invention.

A first invention is a mobile terminal having a displayer on which an icon is displayed on a standby screen and a touch panel provided on the displayer, and executing a function represented by the icon when the icon is selected by a touch operation on the touch panel, comprising a recognizer which, when an input operation of a handwriting character with respect to the touch panel is accepted in a specific region independent of selection of the icon, recognizes the handwriting character; a specifier which specifies a language on the basis of a result of the recognition by the recognizer; and a setter which sets the language specified by the specifier as an in-use language.

In the first invention, the mobile terminal (10) has a displayer such as a display (26) and a capacitive type touch panel (36) provided on the displayer. The displayer displays a standby screen including a GUI, such as a shortcut icon (54) for executing a schedule function, and an icon (56) for notifying information, etc. Furthermore, the mobile terminal 10 executes the schedule function when a touch operation of selecting the shortcut icon is performed on the touch panel. On the displayer, a specific region (60) independent of a selection of an icon is set, and a recognizer (20, S21) recognizes, when a touch operation for inputting a handwriting character is performed within the specific region, a handwriting character by using a dictionary for pattern recognition. For example, when the characters as the recognition result are hiragana characters, Japanese is specified by a specifier (20, S33, S53). Then, in a case that the specified language is Japanese, a setter (20, S41) sets Japanese as an in-use language.

According to the first invention, a user can easily set a language to be used in the mobile terminal by writing a character in a language that the user can understand on the touch panel. That is, it becomes possible to easily perform language setting without constantly displaying a GUI for language setting.

A second invention is according to the first invention, further comprising an receiver which receives an acceptance of a change to the language specified by the specifier, wherein the setter sets the language specified by the specifier as an in-use language when the receiver receives the acceptance.

In the second invention, a receiver (20, S37) receives an operation of accepting a setting change of the in-use language, for example, by a touch operation on the touch panel. The setter changes the setting of the in-use language when the touch operation of accepting the change is performed.

According to the second invention, before changing the setting of the in-use language, the user is required to make confirmation, and whereby, it is possible to prevent an accidental input of the in-use language.

A third invention is according to the second invention, wherein the receiver receives the acceptance of the change in the language specified by the specifier.

In the third invention, if the specified language is English, for example, the receiver receives a change accepting operation after confirmation is performed in English.

According to the third invention, the user can set the in-use language while confirming the language to which a change is made.

A fourth invention is according to the third invention, wherein the displayer displays a confirmation screen described in the language specified by the specifier when the language is specified by the specifier, and the receiver receives a touch operation performed on the confirmation screen as an acceptance of the change.

In the fourth invention, if the specified language is English, for example, the displayer displays a confirmation screen including a pop-up (74a) written in English. Then, the receiver receives a touch operation performed on the confirmation screen as an operation of accepting a change.

According to the fourth invention, the confirmation of the change is displayed on the displayer, and therefore, the user is notified of the language to which a change is made.

A fifth invention is according to any one of the first to fourth inventions, further comprising a list-displayer which, when the character represented by the recognition result is a character to be used by a plurality of languages, displays the plurality of languages as a tabulated list, and the specifier specifies a language on the basis of a result of a selection from the plurality of languages displayed as a tabulated list.

In the fifth invention, a list-displayer (20, S27) displays a plurality of selection keys (72a-72d) corresponding to English, French, Spanish and Portuguese in a case that the character of the recognition result is alphabetical characters. The specifier specifies a language in correspondence with the operated selection key.

According to the fifth invention, the settable languages are displayed as a tabulated list, and therefore, even if the user inputs a character to be used in the plurality of languages, he or she can easily specify the language that the user can understand, and set it as an in-use language.

A sixth invention is according to any one of the first to fifth inventions, wherein the recognizer recognizes the plurality of handwriting characters when an input operation of the plurality of handwriting characters is accepted.

In the sixth invention, when handwriting characters by three characters, for example, are input, the recognizer recognizes each handwriting character.

According to the sixth invention, unless a plurality of sets of handwriting character data are input to the mobile terminal, the character recognition processing is not executed, capable of reducing power consumption of the mobile terminal.

A seventh invention is any one of the first to fourth inventions, wherein the specifier, when the character as a result of the recognition is a specific character for specifying a language, includes a character specifier which specifies the language on the basis of the specific character.

In the seventh invention, the specific character is “ [symbol] ” (“NICHI” Japanese kanji characters) which is brought into correspondence with Japanese, “E” which is brought into correspondence with English, by designers, etc. If the character of the recognition result is “ [symbol] ” (“NICHI” Japanese kanji characters), for example, Japanese is specified by a character specifier (20, S53).

According to the seventh invention, it becomes possible for the user to change the setting of the language by inputting one specific character and easily perform the language setting.

An eighth invention is a language setting program causing a processor (20) of a mobile terminal (10) having a displayer (26) on which an icon (54, 56, 58) is displayed on a standby screen and a touch panel (36) provided on the displayer, and executing a function represented by the icon when the icon is selected by a touch operation on the touch panel to function as: a recognizer (S21) which, when an input operation of a handwriting character with respect to the touch panel is accepted in a specific region (60) independent of selection of the icon, recognizes the handwriting character; a specifier (S33, S53) which specifies a language on the basis of a result of the recognition by the recognizer; and a setter (S41) which sets the language specified by the specifier as an in-use language.

In the eighth invention also, similar to the first invention, the user can easily set a language to be used in the mobile terminal by writing a character that the user can understand on the touch panel.

A ninth invention is a language changing method of a mobile terminal (10) having a displayer (26) on which an icon (54, 56, 58) is displayed on a standby screen and a touch panel (36) provided on the displayer, and executing a function represented by the icon when the icon is selected by a touch operation on the touch panel, comprising: recognizing (S21), when an input operation of a handwriting character with respect to the touch panel is accepted in a specific region (60) independent of selection of the icon, the handwriting character; specifying (S33, S53) a language on the basis of a result of the recognition; and setting (S41) the specified language as an in-use language.

In the ninth invention also, similar to the first invention, a user can easily set a language to be used in the mobile terminal by writing a character that the user can understand on the touch panel.

According to the present invention, by an input of the handwriting characters on the touch panel, the language to be used can be set, and therefore, in the mobile terminal, the language setting can be performed without constantly displaying the GUI for language setting.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an electric configuration of a mobile terminal of one embodiment of a present invention.

FIG. 2 is an illustrative view showing one example of a standby screen to be displayed on a display shown in FIG. 1.

FIG. 3 is an illustrative view showing one example of a plurality of regions to be displayed on the display shown in FIG. 1.

FIG. 4 is an illustrative view showing one example of a language setting procedure by a processor shown in FIG. 1.

FIG. 5 is an illustrative view showing another example of the language setting procedure by the processor shown in FIG. 1.

FIG. 6 is an illustrative view showing one example of a layer structure for depicting a GUI to be displayed on the display shown in FIG. 1.

FIG. 7 is an illustrative view showing one example of a memory map of a RAM shown in FIG. 1.

FIG. 8 is an illustrative view showing one example of a configuration of GUI address data shown in FIG. 7.

FIG. 9 is an illustrative view showing one example of a configuration of GUI data shown in FIG. 7 and an address map.

FIG. 10 is a flowchart showing a part of language setting processing by the processor shown in FIG. 1.

FIG. 11 is a flowchart showing another part of the language setting processing shown in FIG. 1, and sequel to FIG. 10.

FIG. 12 is an illustrative view showing one example of specific characters to be recognized by the processor shown in FIG. 1.

FIG. 13 is a flowchart showing a part of language setting processing of another embodiment by the processor shown in FIG. 1.

### FORMS FOR EMBODYING THE INVENTION

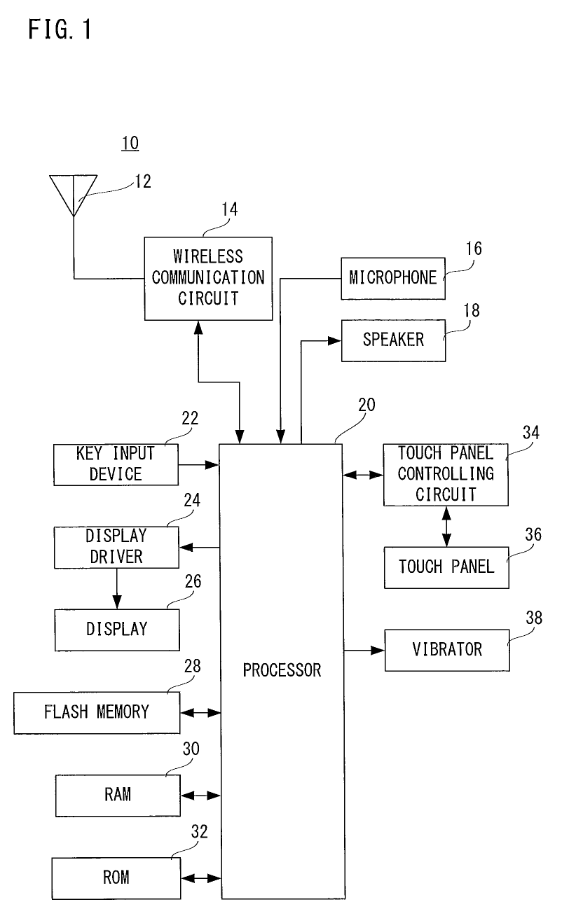

Referring to FIG. 1, a mobile terminal 10 includes a processor (may be called a “CPU” or a “computer”) 20 and a key input device 22. The processor 20 controls a transmitter/receiver circuit 14 compatible with a CDMA system to output a calling signal. The output calling signal is issued from an antenna 12 to mobile communication networks including base stations. When a communication partner performs an off-hook operation, a speech communication allowable state is established.

When a speech communication end operation is performed by the key input device 22 after a shift to the speech communication allowable state, the processor 20 sends a speech communication end signal to the communication partner by controlling the transmitter/receiver circuit 14. Then, after sending the speech communication end signal, the processor 20 ends the speech communication processing. Furthermore, in a case that a speech communication end signal from the communication partner is received as well, the processor 20 ends the speech communication processing. In addition, in a case that a speech communication end signal from the mobile communication network is received independent of the communication partner, the processor 20 ends the speech communication processing.

If a calling signal from the communication partner is received by the antenna 12 in a state that the mobile terminal 10 is started up, the transmitter/receiver circuit 14 notifies an incoming call to the processor 20. The processor 20 vibrates the mobile terminal 10 by driving (rotating) a motor integrated in a vibrator 38 to notify the incoming call to the user. Here, the processor 20 vibrates the vibrator 38, and outputs a ringing tone from a speaker not shown.

Then, the processor 20 displays calling source information sent from the communication partner together with the incoming call signal on a display 26 as a displayer by controlling a display driver 24.

In the speech communication allowable state, the following processing is executed. A modulated audio signal (high frequency signal) sent from the communication partner is received by the antenna 12. The received modulated audio signal is subjected to demodulation processing and decode processing by the transmitter/receiver circuit 14. Then, the received voice signal that is obtained is output from the speaker 18. On the other hand, a voice signal to be transmitted that is captured by the microphone 16 is subjected to encoding processing and modulation processing by the transmitter/receiver circuit 14. Then, the generated modulated audio signal is sent to the communication partner by means of the antenna 12 as in the above description.

A touch panel 36 is a pointing device for designating an arbitrary position within the screen of the display 26. When the touch panel 36 is operated by being pushed, stroked, or touched on its top surface with the finger of the user, it detects the operation. Then, when the finger touches the touch panel 36, a touch panel controlling circuit 34 specifies the position of the finger, and outputs coordinate data of the operated position to the processor 20. That is, the user can input to the mobile terminal 10 a direction of an operation and a design by pushing, stroking, touching, or the like the top surface of the touch panel 36.

Also, the touch panel 36 is a system called an electrical capacitive type in which changes in capacitances between electrodes occurring by an approach of the finger to the surface of the touch panel 36, and detects a touch on the touch panel 36 by one or a plurality of fingers. More specifically, the touch panel 36 adopts a projected capacitive type for detecting changes in capacitances between the electrodes occurring by approach of the finger on a transparent film formed with the electrode patterns. Here, the detection system may include a surface capacitive type, and may also include a resistance film type, a ultrasonic type, an infrared ray type, an electromagnetic induction type, etc. In addition, an origin point of the display coordinates of the display 26 and the touched position coordinates of the touch panel 36 shall be an upper left. That is, the abscissa is larger from the upper left to an upper right, and the ordinate is larger from the upper left to a lower left.

Here, an operation of touching the top surface of the touch panel 36 with the finger of the user shall be referred to as “touch”. On the other hand, an operation of releasing the finger from the touch panel 36 shall be referred to as “release”. Furthermore, an operation of stroking the top surface of the touch panel 36 shall be referred to as “slide”. Then, coordinates indicated by the touch shall be referred to as a “touched point” (touch starting position), and coordinates indicated by the release shall be referred to as a “released point” (touch ending position). In addition, an operation of touching the top surface of the touch panel 36 and then releasing it by the user shall be referred to as a “touch and release”. Then, an operation, such as “touch”, “release”, “slide”, and “touch and release” performed on the touch panel 36 shall generally be referred to as a “touch operation”. Here, the mobile terminal 10 may be provided with a specialized touch pen, etc. for performing a touch operation.

Furthermore, the mobile terminal 10 is provided with a data communication function, and is able to make communications with a server not shown to thereby acquire weather information, etc. Here, during the data communication, the antenna 12 and the transmitter/receiver circuit 14 function as a communication unit, and a server not shown is connected to networks by wire or wirelessly. In addition, the mobile terminal 10 has a schedule function, a calculator function, etc. to be arbitrarily executed by the user.

It should be noted that in the block diagram of the mobile terminal 10 shown in FIG. 1, an illustration of a rechargeable battery will be omitted for simplicity.

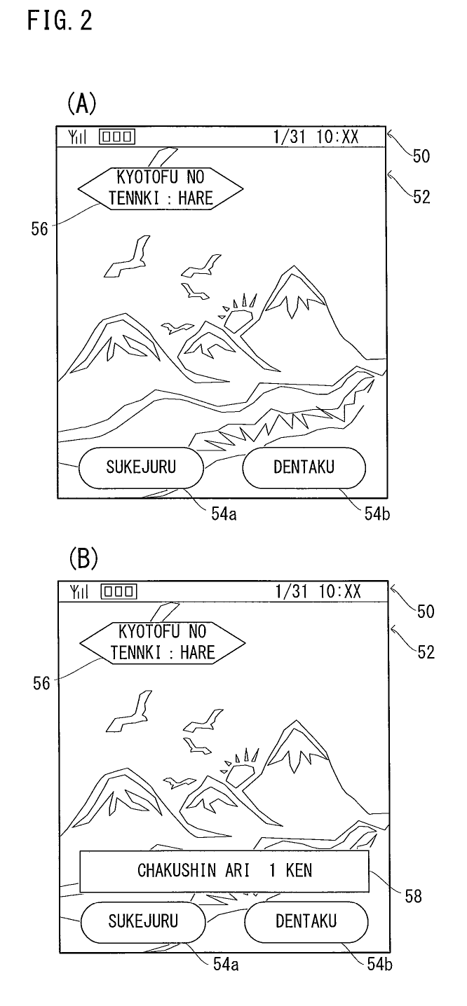

FIG. 2 (A) and FIG. 2 (B) are illustrative views showing one example of standby screens displayed on the display 26. With reference to FIG. 2 (A), the display 26 includes a state displaying region 50 and a function displaying region 52. In the state displaying region 50, a radio wave receiving state by the antenna 12, a remaining capacity of the rechargeable battery, a current date and time, etc. are displayed. Furthermore, in the function displaying region 52, a standby image and a plurality of icons (pict or design may be called) operable by a touch operation are displayed. For example, in FIG. 2 (A), a shortcut icon 54 being made up of a schedule icon 54a and a calculator icon 54b and an information icon 56 displaying weather forecast information of a preset region are displayed.

The schedule icon 54a is a shortcut for executing the above-described schedule function, and the mobile terminal 10 executes the schedule function in response to an operation of the schedule icon 54a. The calculator icon 54b is a shortcut for executing the above-described calculator function, and the mobile terminal 10 executes the calculator function in response to an operation of the calculator icon 54b. Here, the kind and the number of the displayed shortcut icons 54 may arbitrarily be changed.

The information icon 56 indicates information acquired through data communications executed for a fixed time, and in a case that the information icon 56 is operated, the data communication function is executed. For example, when the information icon 56 indicating the weather forecast information is operated, the mobile terminal 10 starts to make data communications with a server storing the weather forecast information. Then, the mobile terminal 10 acquires detailed information such as a chance of precipitation, temperature, etc., and displays the acquired information on the display 26. Here, the information displayed on the information icon 56 is changeable by the user.

With reference to FIG. 2 (B), in the function displaying region 52, a notification icon 58 is further displayed in addition to the shortcut icon 54 and the information icon 56. The notification icon 58 is an icon for notifying information which has not yet confirmed by the user, and when the notified information is confirmed by the user, the display of the notification icon 58 disappears.

For example, the notification icon 58 in FIG. 2 (B) notifies that an incoming call for which incoming call processing was not performed has not yet been confirmed. Furthermore, in a case of the mobile terminal 10 having a mail function, the notification icon 58 may notify that a new incoming mail message has not yet been confirmed.

It should be noted that the state displaying region 50, the function displaying region 52, the function icon 54, the information icon 56 and the notification icon 58 in other drawings are the same as those in FIG. 2 (A) and FIG. 2 (B) unless otherwise stated and therefore, the detailed descriptions in the other drawings are omitted. Here, in the mobile terminal 10 of this embodiment, out of Japanese, Chinese, English, Spanish, Portuguese and Korean, Japanese is set as an in-use language. Thus, Japanese is used for the icons displayed on the display 26 and the menu display. Furthermore, the user can change the display positions of the function icon 54, the information icon 56 and the notification icon 58 by an operation of touching a display region of a certain icon, then sliding, and releasing at an arbitrary position (hereinafter, referred to as a drag and drop).

In this embodiment here, by recognizing a handwriting character input by the user and specifying the language based on the recognition result, the language to be used in the mobile terminal 10 is set.

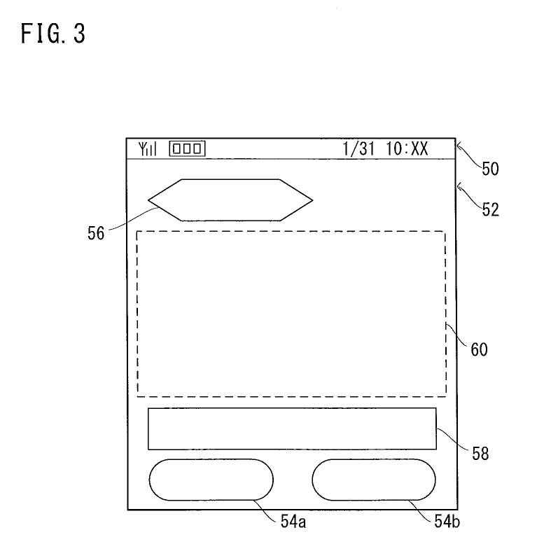

First, an input of the handwriting character is described. With reference to FIG. 3, in the function displaying region 52 of the display 26, a specific region 60 independent of selection of the shortcut icon 54, the information icon 56 and the notification icon 58 is set. Then, an input of the handwriting character is accepted in the specific region 60. That is, accepting an input of a handwriting character in an area irrespective of selection of icons can prevent the icons from being operated accidentally.

Next, recognition of the handwriting character is described. When the user performs a touch operation (sliding operation) of inputting a handwriting character within the specific region 60 of the touch panel 36, a path of the sliding operation is stored in a buffer of a RAM 28. Then, when paths of three characters are stored in the buffer, character recognition processing is performed on each path (handwriting character).

In the character recognition processing of this embodiment, the path of the handwriting character stored in the buffer of the RAM 28 is subjected to noise removal and normalization in size and then is subjected to extraction of the feature quantity. Then, on the basis of the extracted feature quantity, a character is retrieved from the dictionary for pattern recognition stored in a ROM 30. The processor 20 outputs a character acquired by the retrieval as a character of the recognition result. That is, the mobile terminal 10 executes such processing to thereby recognize the handwriting character.

Thus, in this embodiment, unless sets of handwriting character data by three characters are not input, the character recognition processing is never executed, and therefore, it is possible to lower power consumption of the mobile terminal 10. For example, assuming that when the character recognition processing is executed every input of handwriting character data by one character, in response to even an accidental touch operation on the touch panel 36, the character recognition processing is executed, resulting in a waste of power consumption. However, the character recognition processing is never executed before an input of the sets of handwriting character data by three characters, and whereby, even in response to an accidental touch operation on the touch panel 36, the character recognition processing is never executed, and therefore, a waste of the power consumption of the mobile terminal 10 is reduced.

It should be noted that the dictionary for pattern recognition is made up of dictionaries for recognizing hiragana characters, katakana characters, Chinese characters (including simplified Chinese characters, traditional Chinese characters), alphabetical characters and Hangul characters. Furthermore, in this embodiment, for extraction of the feature quantity, a weighted orientation index histogram is utilized, but the feature quantity may be extracted by another technique. Furthermore, for recognition of the handwriting character, two characters may be applied, or four or more characters may be applied, without being restricted to three characters.

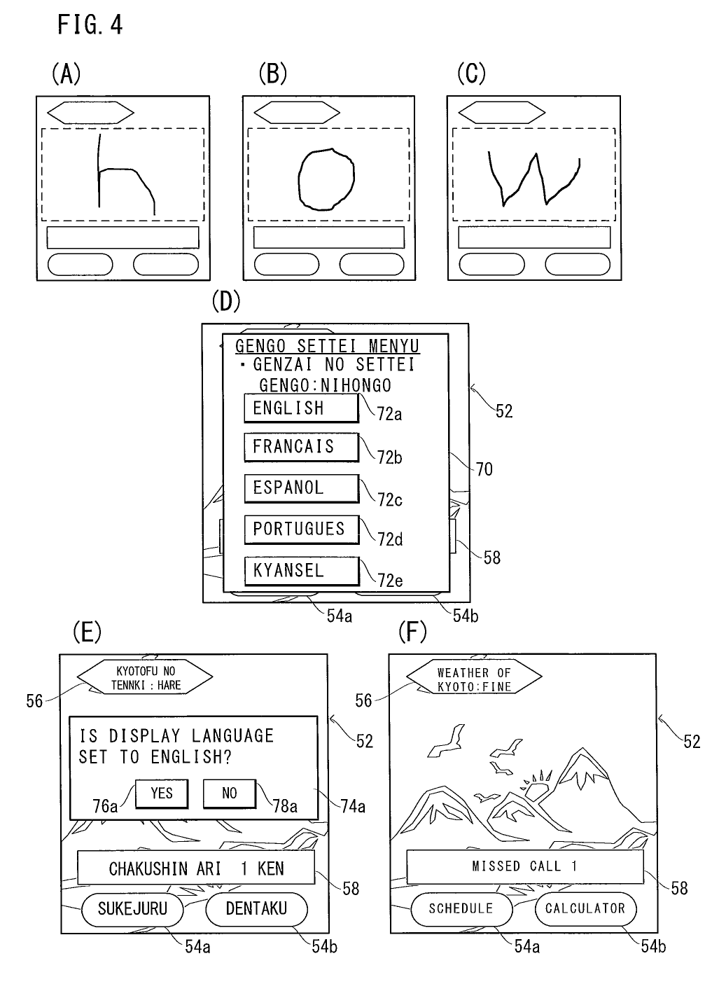

With reference to FIG. 4(A) to FIG. 4(F), an operating procedure of changing setting of an in-use language is described in detail. First, as shown in FIG. 4(A) to FIG. 4(C), when each handwriting character of “h”, “o” and “w” is input to the specific region 60, the processor 20 recognizes them as “h”, “o” and “w” of the alphabetical characters. Then, if the characters of the recognition result are the alphabetical characters, the processor 20 displays keys for selecting languages to be represented by the alphabetical characters, that is, English (ENGLISH), French (FRACAIS), Spanish (ESPANOL) and Portuguese (PORTUGUES) on the display 26.

With reference to FIG. 4(D), on the display 26, a pop-up 70 is displayed, and “GENGO SETTEI MENYU” and “GENZAI NO SETTEI GENGO: NIHONGO” are displayed in the language which is currently set, that is, Japanese, for example within the pop-up 70. Also, within the pop-up 70, a selection key 72a including a character string of “ENGLISH”, a selection key 72b including a character string of “FRANCAIS”, a selection key 72c including a character string of “ESPANOL” and a selection key 72d including a character string of “PORTUGUES” are displayed for specifying the language. Furthermore, the “ENGLISH” within the selection key 72a is English, the “FRANCAIS” within the selection key 72b is French, the “ESPANOL” within the selection key 72c is Spanish, and the “PORTUGUES” within the selection key 72d is Portuguese. That is, the character string in each selection key 72 is described by the corresponding language.

Thus, the settable languages are displayed in a tabulated list, and whereby, even if the user inputs characters used by a plurality of languages, the user can set it to the language that he or she can understand.

Also, within the pop-up 70, the cancellation key 72e for cancelling the language setting is also displayed. Thus, even if the user accidentally displays the pop-up of the language setting menu, the user can erase the pop-up 70 by the cancellation key 72e. Here, in place of the cancellation key 72e, a re-selection key for resetting to the language which is currently set may be displayed. For example, in FIG. 4(D), a re-selection key for reselecting Japanese is displayed.

With reference to FIG. 4(E), when the selection key 72a is operated, English is set as a language to which a change is made. Then, the processor 20 displays a pop-up 74a for requesting an acceptance of a change of the in-use language on the display 26 in English which is specified. Furthermore, within the pop-up 74a, an acceptance key 76a including a character string of “YES” and a denial key 78a including a character string of “NO” are displayed.

With reference to FIG. 4(F), when the acceptance key 76a, for example, is operated, the in-use language is set to English, and each icon is displayed in English. That is, the schedule icon 54a is represented by a character string of “SCHEDULE”, and the calculator icon 54b is represented by a character string of “CALCULATOR”. Furthermore, the information icon 56 includes a character string of “WEATHER OF KYOTO: FINE”, and the notification icon 58 is represented by a character string “MISSED CALL 1”. On the other hand, when the denial key 78a shown in FIG. 4(E) is operated, the display shown in FIG. 4(E) returns to the display shown in FIG. 2 (B) without change of the in-use language.

Thus, before changing the setting of the in-use language, the user is required to confirm it, and whereby, it is possible to prevent the in-use language being accidentally set. Furthermore, before the in-use language is changed, confirmation is made in the language to which a change is made, and therefore, the user can set the in-use language while recognizing the language to which a change is made. In addition, confirmation of the change is displayed on the display 26, and therefore, it is possible to accurately notify the user of the language to which a change is made.

Here, if any one of the selection keys 72b-72d is selected in FIG. 4(D), an acceptance of a change of the in-use language is asked in the language corresponding to each selection key. That is, if the selection key 72b is selected, the pop-up 74a described in French is displayed. Alternatively, if the selection key 72c is selected, the pop-up 74a described in Spanish is displayed, and if the selection key 72d is selected, the pop-up 74a described in Portuguese is displayed.

Furthermore, for simplicity, although illustration is omitted, if the recognized character is Chinese characters, selection keys for selecting Japanese, Chinese and Korean are displayed within the pop-up 70 shown in FIG. 4(D).

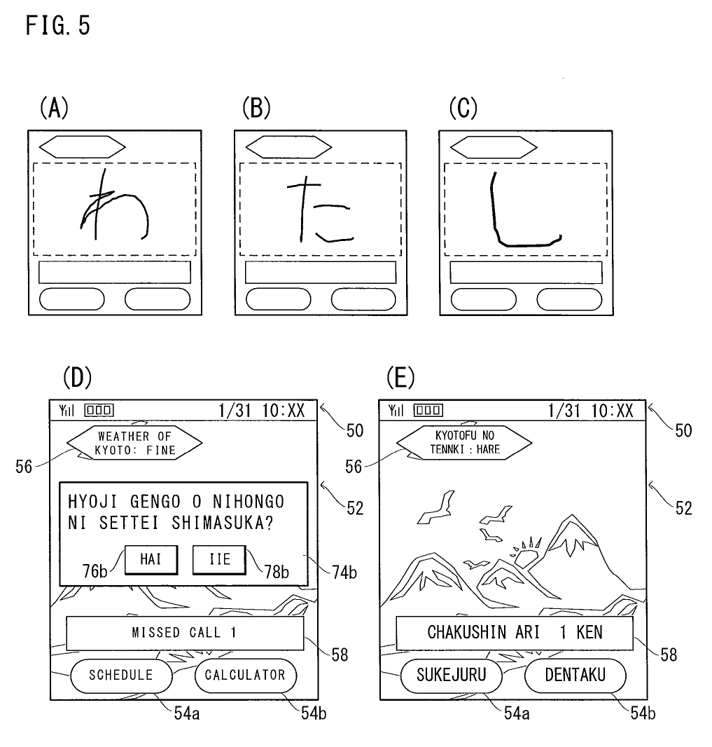

Next, a case that the language corresponding to the character of the recognition result is one kind is explained. With reference to FIG. 5(A) to FIG. 5(C), when handwriting characters indicating “ [symbol] ” (“wa” Japanese hiragana characters), “ [symbol] ” (“ta” Japanese hiragana characters) and “ [symbol] ” (“shi” Japanese hiragana characters) are continuously input, the processor 20 recognizes “ [symbol] ” (“wa” Japanese hiragana characters), “ [symbol] ” (“ta” Japanese hiragana characters) and “ [symbol] ” (“shi” Japanese hiragana characters) of hiragana characters. Then, the processor 20 specifies Japanese as a language to be set as an in-use language. That is, the hiragana characters are only used in Japanese, and thus, the processor 20 can specify the characters as Japanese.

With reference to FIG. 5(D), the processor 20 displays the pop-up 74b that asks an acceptance of a change in Japanese on the display 26. In addition, within the pop-up 74b, an acceptance key 76b including the character string of “HAI” and a denial key 78b including the character string of “IIE” are displayed. Then, when the acceptance key 76b is operated, the respective icons displayed on the standby screen are displayed in Japanese as shown in FIG. 5(E). For example, in a case that the in-use language has been set to English, the display of each icon is changed from English to Japanese.

Thus, the user can more easily perform the operation of changing the setting of the in-use language by recognition of a character only used in the language to which setting is made.

Although illustration is omitted, even if the characters of the recognition result are the katakana characters, the GUI shown in FIG. 5(D) is displayed similar to the hiragana characters. In addition, if the characters of the recognition result are the Hangul characters, the GUI shown in FIG. 5(D), that is, the pop-up 74b, the acceptance key 76b and the denial key 78b are described in Hangul.

Here, in a case that the pop-ups 74a, 74b are not discriminated from each other, they are called the pop-up 74. In a case that the acceptance keys 76a, 76b are not discriminated from each other also, they are called the acceptance key 76, and in a case of the denial keys 78a, 78b as well, they are called the denial key 78. Furthermore, in this embodiment, a screen where the pop-up 74 is displayed may sometimes be called a confirmation screen.

Furthermore, as a result of character recognition, if three characters are not the same kind, the language is specified on the basis of the most kind of the characters. For example, if out of the characters of the recognition result, two characters are the hiragana characters, and one character is the kanji characters, the language is specified based on the hiragana characters. In addition, if three characters are different kinds, the language is specified based on the character having the highest value indicating accuracy of the character recognition (likelihood, for example). For example, in a case that the characters of the recognition result are the hiragana characters, the katakana characters and the kanji characters, if likelihood of the katakana characters is the highest, the language is specified based on the katakana characters.

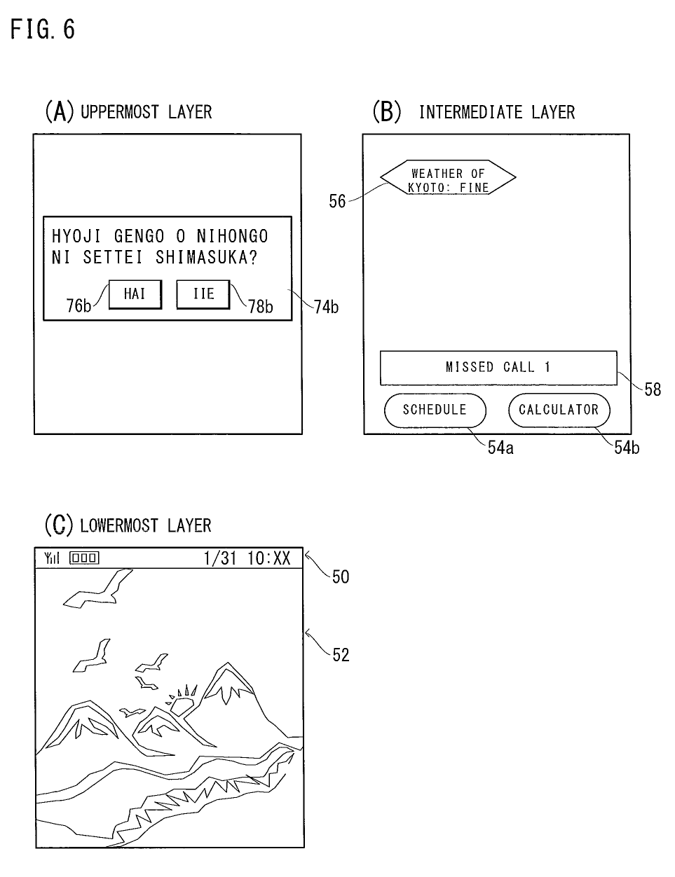

Here, a plurality of layers making up of a display of the display 26 are described. More specifically, as shown in FIG. 6(A) to FIG. 6(C), three layers (uppermost layer, intermediate layer, lowermost layer) are overlaid on each other, and in the virtual space, on the side of a point of view (user), the uppermost layer is provided, and in a direction away from the point of view, the intermediate layer and the lowermost layer are arranged in this order. On the uppermost layer shown in FIG. 6(A), the pop-up 74b, the acceptance key 76b and the denial key 78b are depicted. Here, depending on the function to be executed by the mobile terminal 10, no image may be depicted on the uppermost layer.

On the intermediate layer shown in FIG. 6(B), the function icon 54, the information icon 56 and the notification icon 58, for example, are depicted. Also, depending on the function to be executed by the mobile terminal 10, a further icons may be displayed on the intermediate layer. On the lowermost layer shown in FIG. 6(C), the state displaying region 50 and the function displaying region 52 are depicted.

Thus, the icons on the intermediate layer and depiction of the pop-up of the uppermost layer are independent of each other, and therefore, the processor 20 can perform processing of changing the display of the display 26 for a short time.

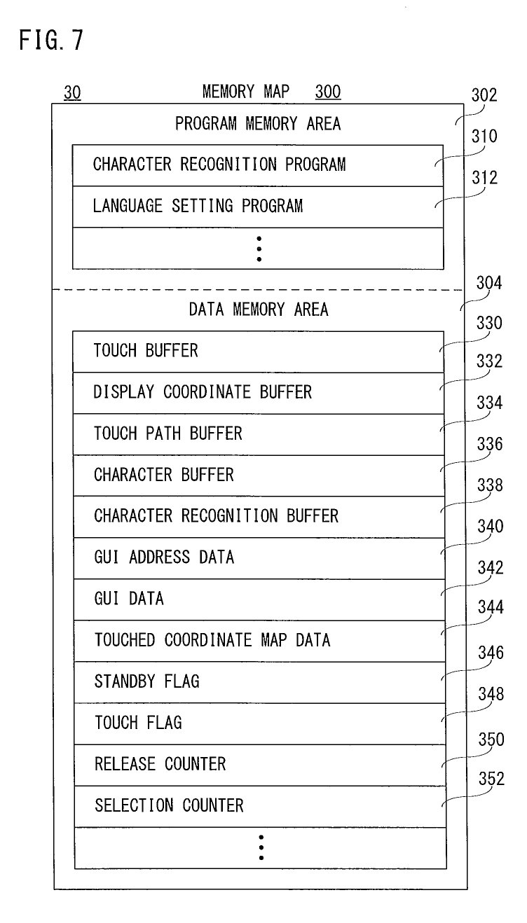

FIG. 7 is an illustrative view showing a memory map of the RAM 30. With reference to FIG. 7, in the memory map of the RAM 30, a program memory area 302 and a data memory area 304 are included. A part of programs and data are read entirely at a time, or partially and sequentially as necessary from the flash memory 28, stored in the RAM 30, and then executed by the processor 20, etc.

In the program memory area 302, a program for operating the mobile terminal 10 is stored. The program for operating the mobile terminal 10 is made up of a character recognition program 310, a language setting program 312, etc.

The character recognition program 310 is a program for recognizing a handwriting character input by the touch panel 36. The language setting program 312 is a program for setting a language to be used in the mobile terminal 10. Here, although illustration is omitted, a program for operating the mobile terminal 10 includes a program for making communications, a program for making data communications with servers on networks, etc.

In the data memory area 304, a touch buffer 330, a display coordinate buffer 332, a touch path buffer 334, a character buffer 336, a character recognition buffer 338, etc. are provided. Furthermore, in the data memory area 304, GUI address data 340, GUI data 342 and touched coordinate map data 344, etc. are stored, and a standby flag 346, a touch flag 348, a release counter 350, a selection counter 352, etc. are provided.

The touch buffer 330 is a buffer for temporarily storing an input result by a touch, etc. detected by the touch panel 36, and temporarily stores coordinate data of a touched point, a release point, and a current touched position. The display coordinate buffer 332 is a buffer for temporarily storing display position coordinates of a plurality of icons displayed on the display 26, and position coordinates of the specific region 60. That is, if an input operation of a handwriting character, a selecting operation of an icon, or the like is performed, the data stored in the display coordinate buffer 332 is referred.

The touch path buffer 334 is a buffer for recording a path of the touched positions during a sliding operation, and the path of the touch until an input operation of a handwriting character is determined is recorded in the touch path buffer 334.

The character buffer 336 is a buffer for storing the path of the sliding determined as a handwriting character. That is, in a case that a handwriting character is determined, the paths of the touch stored in the touch path buffer 334 are stored in the character buffer 336 as it is. The character recognition buffer 338 is a buffer to be utilized when the processing of the character recognition program 310 is executed, and stores data on which noise removal and normalization of size are performed.

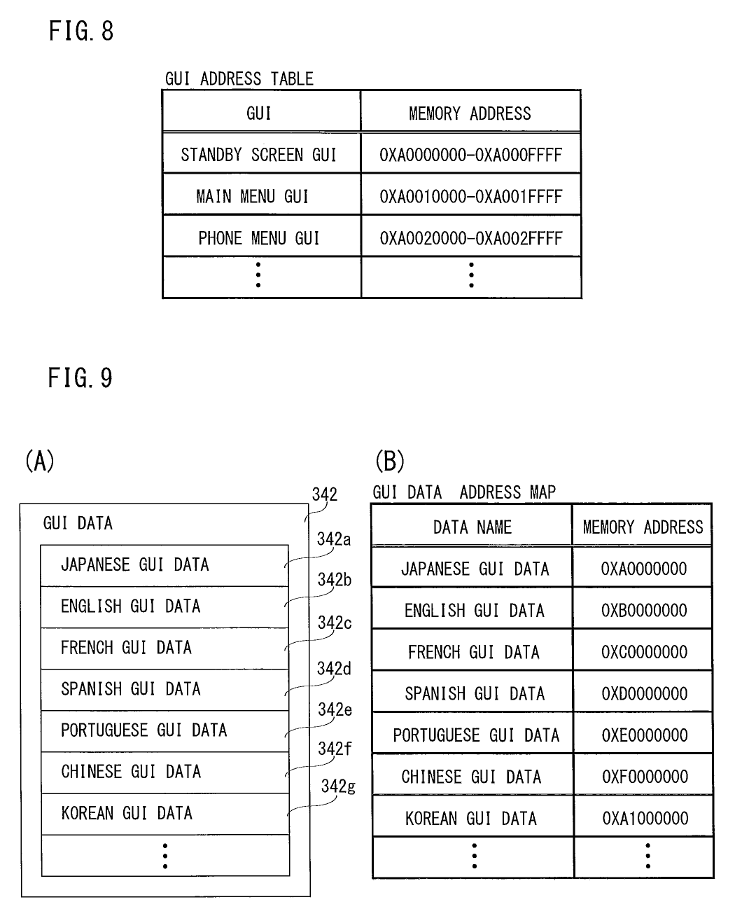

The GUI address data 340 is data to be referred when the GUI data 342 described later is read out, and includes a memory address of the data area where the GUI data 342 is stored. For example, with reference to FIG. 8, the GUI address table is one example of a configuration of the GUI address data 340. The GUI address table includes a column of the GUI and a column of the memory address, and in the column of the GUI, a standby screen GUI representing a GUI such as the icons and the pop-up to be displayed on the standby screen, a main menu GUI representing a GUI such as the main menu for allowing a change of the setting of the mobile terminal 10 and a telephone menu GUI representing a GUI of each menu in the phone function GUI, etc. are recorded. Then, in the column of the memory address, the memory address of the data area is stored by being brought into correspondence with the column of GUI.

For example, the GUI data to be displayed on the standby screen is stored in a data area indicated by memory addresses of “0XA0000000” to “0XA000FFFF”. Furthermore, the GUI data of the main menu is stored in a data area indicated by memory addresses of “0XA0010000” to “0XA001FFFF”, and the GUI data of the telephone menu is stored in a data area indicated by memory addresses of “0XA0020000” to “0XA002FFFF”. Here, in this embodiment, the first memory address of each data area is called a beginning address. For example, the beginning address of the data area in which the GUI data of the standby screen is stored is “0XA0000000”.

Returning to FIG. 7, the GUI data 342 includes image data and character string data for displaying the function icon 54, the information icon 56 and the notification icon 58, for example, that are to be displayed on the display 26. Furthermore, with reference to FIG. 9(A), the GUI data 346 includes Japanese GUI data 346a, English GUI data 346b, French GUI data 346c, Spanish GUI data 346d, Portuguese GUI data 346e, Chinese GUI data 346f and Korean GUI data 346g.

Then, with reference to FIG. 9(B), in the address map of the GUI data 342, a beginning address of each data is shown. That is, the beginning address of the data area in which the Japanese GUI data 342a is stored is “0XA0000000”, as to the English GUI data 342b, the beginning address is “0XB0000000”, as to the French GUI data 342c, the beginning address is “0XC0000000”, as to the Spanish GUI data 342d, the beginning address is “0XD0000000”, as to the Portuguese GUI data 342e, the beginning address is “0XE0000000”, as to the Chinese GUI data 342f, the beginning address is “0XF0000000”, and as to the Korean GUI data 342g, the beginning address is “0XA1000000”.

With reference, here, to FIG. 8 and FIG. 9(B), in the mobile terminal 10 of this embodiment, when the in-use language is set to English, the memory address corresponding to the standby screen GUI is changed to “0XB0000000” to “0XB000FFFF” on the basis of the beginning address of the English GUI data 342b. In addition, in accordance with the change of the standby screen GUI, the memory addresses corresponding to the main menu GUI and the telephone menu GUI are also changed. That is, when the setting of the in-use language is changed, the memory address to be referred when the GUI data 342 is read out is changed.

Returning to FIG. 7, the touched coordinate map data 344 is data for bringing coordinates such as a touched point specified by the touch panel control circuit 34 into correspondence with the display coordinates of the display 26. That is, the processor 20 can bring a result of a touch operation performed on the touch panel 36 into correspondence with the display of the display 26 on the basis of the touched coordinate map data 334.

The standby flag 346 is a flag for determining whether or not the standby screen is displayed on the display 26. For example, the standby flag 346 is made up of one bit register. When the standby flag 346 is turned on (established), a data value “1” is set to the register. On the other hand, if the standby flag 346 is turned off (not established), a data value “0” is set to the register. Furthermore, the standby flag 346 is turned on when an operation of displaying the standby screen is performed, and it is turned off when an operation of changing to another screen is performed with the standby screen displayed.

The touch flag 348 is a flag for determining whether or not a touch is made on the touch panel 36. Here, the configuration of the touch flag 348 is the same as that of the standby flag 346, and therefore, the description in detail is omitted.

The release counter 350 is a counter for counting a time from when the finger is released from the touch panel 36. Furthermore, the selection counter 352 is a counter for counting a time from when the pop-up 70 or the pop-up 74 is displayed in the language setting processing.

Although illustration is omitted, in the data memory area 304, standby image data to be displayed on the standby screen, address book data being made up of phone numbers set to other mobile terminals 10, etc. are stored, and counters and flags necessary for operating the mobile terminal 10 are also provided.

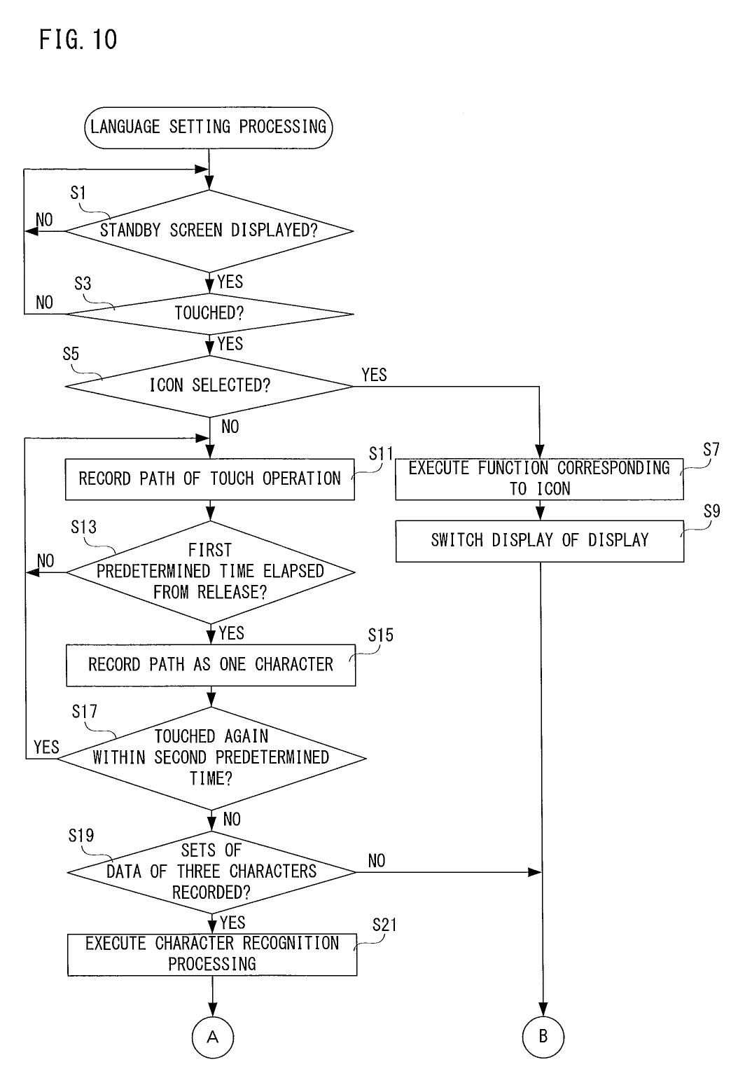

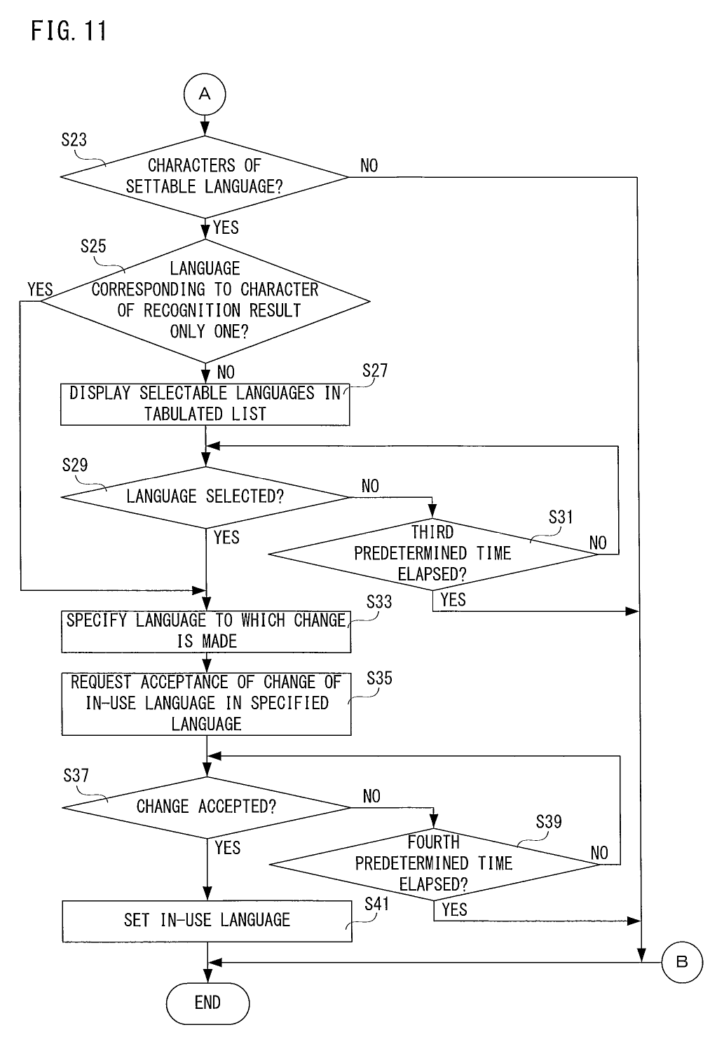

The processor 20 performs in parallel a plurality of tasks including language setting processing, etc. shown in FIG. 10 and FIG. 11 under the control of RTOS (Real-time Operating System), such as “Linux (registered trademark)”, “REX”, etc.

FIG. 10 is a flowchart showing the language setting processing. For example, when the power of the mobile terminal 10 is turned on, the processor 20 determines whether or not the standby screen is displayed in a step S1. That is, it is determined whether or not the standby flag 346 is turned on. If “NO” in the step S1, that is, if the standby screen is not displayed, the determination in the step S1 is repeatedly executed. On the other hand, if “YES” in the step S1, that is, if the standby screen is displayed, it is determined whether or not a touch is performed in a step S3. That is, it is determined whether or not the touch flag 348 is turned on.

If “NO” in the step S3, that is, if a touch is not performed, the process returns to the step S1. On the other hand, if “YES” in the step S3, that is, if a touch is performed, it is determined whether or not an icon is operated in a step S5. That is, it is determined whether or not a touched point stored in the touch buffer 330 is included in the display coordinates of the icon stored in the display coordinate buffer 332. Here, owing to such a determination in the step S5, in a case that a path of a handwriting character passes through the display range of an icon during an input of the handwriting character, and in a case that the end portion in an input of a handwriting character is included in a display range of an icon, this is not determined as the icon being operated. That is, even if a path of a sliding after a touch and a release point are included in the display region in a state that the touched point is included in the specific region 60, this cannot be determined as an operation of selecting an icon.

If “YES” in the step S5, that is, if the icon is operated, a function indicated by the icon is executed in a step S7, and depending on the function to be executed, the display on the display 26 is switched in a step 9. Then, after completion of the processing in the step S9, the language setting processing is ended. For example, if the touched point is included in the display range of the schedule icon 54a, the processor 20 executes the schedule function, and displays a GUI corresponding to the schedule function on the display 26.

Alternatively, if “NO” in the step S5, that is, if no icon is operated, and the touched point is included in the specific region 60, the path of the touch operation is recorded. For example, a change history of the touched position by the sliding operation is recorded in the touch path buffer 334. Here, if the touched point is not included in the specific region 60 as well, the processing in the step S5 is repetitively executed. Succeedingly, in a step S13, it is determined whether or not a first predetermined time (0.2 sec., for example) has elapsed from the release. That is, it is determined whether or not an input of the first character continues. Here, for the determination of the first predetermined time, the value of the release counter 350 is referred.

If “NO” in the step S13, that is, if the first predetermined time has not elapsed, the process returns to the step S11 to continue to record the path of the sliding operation. On the other hand, if “YES” in the step S13, that is, if the first predetermined time has elapsed, the path is recorded as one character in a step S15. That is, the path of the sliding operation stored in the touch path buffer 334 is stored in the character buffer 336. Here, in this embodiment, data of one character is recorded by means of a two-dimensional array.

Succeedingly, in a step S17, it is determined whether or not a touch is performed again within a second predetermined time (one second, for example). That is, it is determined whether or not an operation of inputting the next handwriting character is started. Here, for the determination of the second predetermined time as well, the value of the release counter 350 is referred. If “YES” in the step S17, that is, if inputting the next handwriting character is started, the process returns to the step S11. On the other hand, if “NO” in the step S17, that is, if the operation of inputting the next handwriting character is not performed within the second predetermined time, it is determined whether or not sets of data of three characters are recorded in a step S19. For example, it is determined whether or not the two-dimensional arrays of the three characters are stored in the character buffer 336. If “NO” in the step S19, that is, if the sets of data of the three characters are not recorded, the language setting processing is ended. On the other hand, if “YES” in the step S19, that is, if sets of data of the three characters are recorded, the character recognition processing is executed in a step S21. That is, the character recognition processing is performed on the sets of data of the handwriting characters stored in the character buffer 336. Here, the processor 20 executing the processing in the step S21 functions as a recognizer.

With reference to FIG. 11, it is determined whether or not the characters are characters of a settable language in a step S23. That is, it is determined whether or not the characters are hiragana characters, katakana characters, Chinese characters, alphabetical characters or Hangul characters. If “NO” in the step S23, that is, if they are not the settable character, the language setting processing is ended. On the other hand, if “YES” in the step S23, specifically, if the recognized character is the hiragana characters, the alphabetical characters, or the like, it is determined whether or not the language corresponding to the characters of the recognition result is only one in a step S25. That is, it is determined whether or not the character of the recognition result is the hiragana characters, the katakana characters or the Hangul characters.

Here, in the step S23, if the characters of the recognition result are symbols (@, +, etc.) or numerals (1, 2, . . . ), “NO” may be determined. Furthermore, it may be determined whether or not the characters of the recognition result are the alphabetical characters or the Chinese characters in the step S25.

If “YES” in the step S25, that is, if the characters of the recognition result are the hiragana characters, the katakana characters or the Hangul characters, the process proceeds to a step S33. On the other hand, if “NO” in the step S25, that is, if the characters of the recognition result are the alphabetical characters or the kanji characters, the selectable languages are displayed in a tabulated list in a step S27. For example, if the characters of the recognition result are the alphabetical characters, English, French, Spanish and Portuguese are shown in the tabulated list as shown in FIG. 4(D). Furthermore, if the characters of the recognition result are the kanji characters, Japanese, Chinese and Korean are shown in the tabulated list. Here, the processor 20 executing the processing in the step S27 functions as a list-displayer.

Succeedingly, in a step S29, it is determined whether or not a language is selected. For example, it is determined whether or not any one of the selection keys 72a to 72d displayed on the display 26 is operated. If “NO” in the step S29, that is, if the selection key is not selected, it is determined whether or not a third predetermined time (5 sec, for example) has elapsed in a step S31. That is, in the step S31, it is determined whether or not the respective selection keys are continuously displayed. Furthermore, when the lapse of the third predetermined time is determined, the value of the selection counter 352 is referred.

If “NO” in the step S31, that is, if the third predetermined time has not elapsed, the process returns to the step S29. On the other hand, if “YES” in the step S31, the pop-up 70 and the selection keys 72a-72d displayed on the display 26 are erased, and the language setting processing is ended. Here, in a case that the cancellation key 72e is operated as well, the language setting processing is ended.

Alternatively, if “YES” in the step S29, that is, if any one of the selection keys 72a-72d is selected, the language to which a change is made is specified in a step S33. For example, if the selection key 72a corresponding to English is operated, the language to which a change is made is specified as English. Or, if the characters of the recognition result are the hiragana characters, the language to which a change is made is specified as Japanese. Here, the processor 20 executing the processing in the step S33 functions as a specifier.

Succeedingly, in a step S35, an acceptance of a change of the in-use language is received in the specified language. For example, if the specified language is English, the GUI, that is, the pop-up 74a, the acceptance key 76a and the denial key 78a that are described in English are displayed on the display 26 as shown in FIG. 4(E). Alternatively, if the specified language is Japanese, the GUI, that is, the pop-up 74b, the acceptance key 76b and the denial key 78b that are described in Japanese are displayed on the display 26 as shown in FIG. 5(D). Here, a request of the acceptance of the change of the language may be performed by voice emitted by the specific language.

Succeedingly, in a step S37, it is determined whether or not the change is accepted. That is, it is determined whether or not a touch operation performed on the acceptance key 76 is received. If “NO” in the step S37, that is, if the acceptance key 76 and the denial key 78 are not operated, it is determined whether or not a fourth predetermined time (10 sec., for example) has elapsed in a step S39. That is, it is determined whether or not a request of the acceptance of the change of the language has continued. Here, when the lapse of the fourth predetermined time is determined as well, the value of the selection counter 352 is referred. If “NO” in the step S39, that is, if the fourth predetermined time has not elapsed, the process returns to the step S37. On the other hand, if “YES” in the step S39, that is, if the fourth predetermined time has elapsed, the GUI displayed on the display 26 is erased, and the language setting processing is ended. Here, in a case that the denial key 78 is operated as well, the language setting processing is ended.

Alternatively, if “YES” in the step S37, that is, if the acceptance key 76 is operated, the in-use language is set in a step S41, and the language setting processing is ended. That is, the memory addresses of the data area recorded in the GUI address data 340 is changed to the memory addresses corresponding to the set language. Here, the processor 20 executing the processing in the step S37 functions as an receiver, and the processor 20 executing the processing in the step S41 functions as a setter.

It should be noted that in this embodiment, in a case that the in-use language is set to English in the step S41, the character string stored in the server is translated into English and then obtained. Here, the translating processing is performed on the side of the server, but may be set to be performed on the mobile terminal 10.

Also, the language setting processing may be performed by repetition of the processing in the steps S1 to S41. That is, eve after completion of the language setting processing, the processing in the step S1 is executed again. Also, the language setting processing may be executed from the processing in the step S3 without performing the step S1 when the standby flag 346 is turned on, and may be ended when the standby flag 346 is turned off.

Alternatively, in another embodiment, it is determined whether or not a character of the recognition result is a specific character for specifying a language and whereby, the language may be specified.

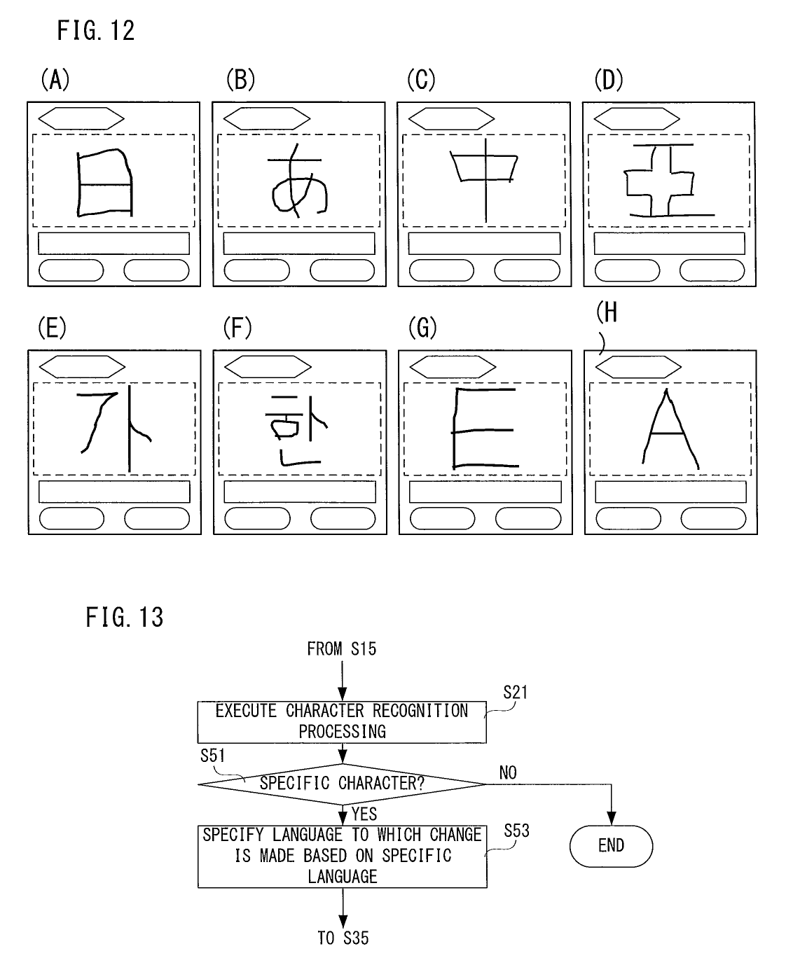

With reference to FIG. 12(A) and FIG. 12(B), if a specific handwriting character indicating Japanese is input in the specific region 60, Japanese is specified as a language to which a change is made. Furthermore, with reference to FIG. 12(C) and FIG. 12(D), if a specific handwriting character indicating Chinese is input in the specific region 60, Chinese is specified as a language to which a change is made. Also, if Hangul characters shown in FIG. 12(E) and FIG. 12(F) are input as handwriting characters, Korean is specified as a language to which a change is made. Then, with reference to FIG. 12(G) and FIG. 12(H), if a specific handwriting character indicating English is input, English is specified as a language to which a change is made.

Here, the specific characters are preset by designers of the mobile terminal 10. Then, a character for specifying other languages such as French, etc. may be preset by designers.

Moreover, with reference to FIG. 13, as language setting processing, after the processing in the step S15 (see FIG. 10), character recognition processing is executed in the step S21. Succeedingly, in a step S51, it is determined whether or not the input character is a specific character. That is, it is determined whether or not the input character is any one of the eight characters shown in FIG. 12(A) to FIG. 12(H). If “NO” in the step S51, that is, if it is not the specific character, the language setting processing is ended. On the other hand, if “YES” in the step S51, that is, if it is the specific character, the language to which a change is made is specified on the basis of the specific character in a step S53, and the process proceeds to the step S35. For example, in the step S53, if the character of the recognition result is the specific character shown in FIG. 12(A) or FIG. 12(B), the language to which a change is made is specified as Japanese.

This makes it possible for the user to change the language setting by inputting the specific character and to perform a change of the language setting more easily.

As understood from the above description, the mobile terminal 10 has the display 26 and the touch panel 36 provided on the display 26. On the display 26, the standby screen including the shortcut icon 54, the information icon 56 and the notification icon 58 is displayed, and the specific region 60 independent of selection of these icons is further set.

When a handwriting character is input in the specific region 60 according to a touch operation, the processor 20 executes the character recognition processing to thereby recognize the handwriting character. Furthermore, if the characters of the recognition result are the hiragana characters, the processor 20 specifies them as Japanese. Then, the processor 20 requests a change of the in-use language by the pop-up 74b and the acceptance key 76b that are described in Japanese, and in response to an operation of the acceptance key 76b, the language to be used in the mobile terminal 10 is set to Japanese.

This makes it possible for the user to set the language to be used by an input of a handwriting character with respect to the touch panel 36. Also this makes it possible for the mobile terminal 10 to easily set the language without constantly displaying the GUI for the language setting.

Additionally, in this embodiment, an operation of changing a display position of an icon by a drag and drop is included in an operation of selecting an icon. A drag and drop such as touching a display range of a certain icon and releasing it in a display range of another icon is also included in the operation of selecting an icon. That is, the processor 20 does not regard a drag and drop performed on an icon as an input operation of a handwriting character.

In addition, in another embodiment, in a case that the display position of an icon cannot be changed by a drag and drop, if sliding by a predetermined distance (10 mm, for example) is performed after a touch, an input of a handwriting character may be determined without determining a selecting operation of an icon. That is, in such a case, the function displaying region 52 and the specific region 60 may be set in the same size.

Furthermore, on the display 26, an LCD monitor is used, but other display devices, such as an organic light emitting panel, may be used.

In addition, in the language recognition processing, many characters such as Cyrillic characters like those of Russian may be recognized. Then, it may be designed to set a lot of languages such as Russian as a language settable to the mobile terminal 10. In addition, in a case of the mobile terminal 10 having a character input function, when the in-use language is changed, the initial state of the character input mode is also changed in accordance therewith. For example, if the in-use language is changed from Japanese to English, the initial state of the character input mode is changed from a Japanese character input mode to an English character input mode.

Moreover, for the communication system of the mobile terminal 10, a W-CDMA system, a TDMA system, a PHS system and a GSM system, etc. may be adopted without being restricted to the CDMA system. A handheld terminal such as a PDA (Personal Digital Assistant) having a sliding mechanism, a notebook PC, etc. may be possible without being restricted to only the mobile terminal 10.

Then, concrete numerical values of the times, the distances, and the memory addresses given in this embodiment are entirely one example, and can be change depending on specifications of products.

Although the present invention has been described and illustrated in detail, it is clearly understood that the same is by way of illustration and example only and is not to be taken by way of limitation, the spirit and scope of the present invention being limited only by the terms of the appended claims.

### EXPLANATION OF REFERENCE CHARACTERS

10 . . . mobile terminal
20 . . . processor
22 . . . key input device
26 . . . display
32 . . . ROM
36 . . . touch panel

1. A mobile terminal having a displayer for on which an icon is displayed on a standby screen and a touch panel provided on said displayer, and executing a function represented by said icon when said icon is selected by a touch operation on said touch panel, comprising:
a recognizer which, when an input operation of a handwriting character with respect to said touch panel is accepted in a specific region independent of selection of said icon, recognizes said handwriting character;
a specifier which specifies a language on the basis of a result of the recognition by said recognizer; and
a setter which sets the language specified by said specifier as an in-use language.

2. A mobile terminal according to claim 1, further comprising an receiver which receives an acceptance of a change to the language specified by said specifier, wherein
said setter sets the language specified by said specifier as an in-use language when said receiver receives the acceptance.

3. A mobile terminal according to claim 2, wherein said receiver receives the acceptance of the change in the language specified by said specifier.

4. A mobile terminal according to claim 3, wherein said displayer displays a confirmation screen described in the language specified by said specifier when the language is specified by said specifier, and
said receiver receives a touch operation performed on said confirmation screen as an acceptance to the change.

5. A mobile terminal according to claim 1, further comprising a list-displayer which, when the character represented by said recognition result is a character to be used by a plurality of languages, displays said plurality of languages as a tabulated list, and
said specifier specifies a language on the basis of a result of a selection from said plurality of languages displayed as a tabulated list.

6. A mobile terminal according to claim 1, wherein said recognizer recognizes said plurality of handwriting characters when an input operation of the plurality of handwriting characters is accepted.

7. A mobile terminal according to claim 1, wherein said specifier, when the character as a result of the recognition is a specific character for specifying a language, includes a character specifier which specifies the language on the basis of said specific character.

8. A language setting program causing a processor of a mobile terminal having a displayer on which an icon is displayed on a standby screen and a touch panel provided on said displayer, and executing a function represented by said icon when said icon is selected by a touch operation on said touch panel to function as:
a recognizer which, when an input operation of a handwriting character with respect to said touch panel is accepted in a specific region independent of selection of said icon, recognizes said handwriting character;
a specifier which specifies a language on the basis of a result of the recognition by said recognizer; and
a setter which sets the language specified by said specifier as an in-use language.

9. A language changing method of a mobile terminal having a displayer on which an icon is displayed on a standby screen and a touch panel provided on said displayer, and executing a function represented by said icon when said icon is selected by a touch operation on said touch panel, comprising:
recognizing, when an input operation of a handwriting character with respect to said touch panel is accepted in a specific region independent of selection of said icon, said handwriting character;
specifying a language on the basis of a result of the recognition; and
setting the specified language as an in-use language.
